(19) United States
(12) Patent Application Publication
(10) Pub. No.: US 2026/0109589 A1
(43) Pub. Date: Apr. 23, 2026

(54) WATER PURIFIER

(71) Applicant: COWAY CO., LTD., Gongju-si (KR)

(72) Inventors: Seung Won LEE, Gongju-si (KR); Hee Do JUNG, Gongju-si (KR); Dong Min OH, Gongju-si (KR); Jong Hwan LEE, Gongju-si (KR); Hyun Kang LEE, Gongju-si (KR); Hee Joo KANG, Gongju-si (KR); Seong Min PARK, Gongju-si (KR); Yoo Won OH, Gongju-si (KR); Da Woon JUNG, Gongju-si (KR); Hyun Goo KIM, Gongju-si (KR); Byung Hyo YE, Gongju-si (KR)

(73) Assignee: COWAY CO., LTD., Gongju-si (KR)

(21) Appl. No.: 18/872,065

(22) PCT Filed: Mar. 31, 2023
(86) PCT No.: PCT/KR2023/004359

§ 371 Date: Dec. 5, 2024

(30) Foreign Application Priority Data
Jun. 7, 2022 (KR) 10-2022-0068709

(51) Int. Cl. B67D 1/08; B67D 1/00

(52) U.S. Cl. CPC B67D 1/0884; B67D 1/0014; B67D 1/0869; B67D 1/0895; B67D 2210/0001; B67D 2210/00034

(57) ABSTRACT

A water purifier has a power supply of a controller and a first board disposed on one side portion and the other side portion of a water treatment module, respectively, and an external power line connected to the first board to supply external power extends along a first side of the water treatment module and an AC power line for transmitting AC power to the power supply extends along a second side of the water treatment module different from the first side to be spaced a predetermined interval or more from the external power line. Therefore, the effect of noise of the AC power line on the external power line is minimized, and thus the electrical stability of the apparatus is improved.

### TECHNICAL FIELD

The present invention relates to a water purifier, and more particularly, to a water purifier with improved electrical stability.

### BACKGROUND

A water purifier is an apparatus that filters out and removes impurities from raw water through physical and chemical methods and then supplies it.

In recent years, water purifiers have been incorporating various electrical components, such as heaters for providing hot water and thermoelectric elements for providing cold water, in order to shorten the time required to provide hot water and cold water. In addition, water purifiers include a power supply such as a switching mode power supply (SMPS) to provide stable power to various electrical components.

Meanwhile, the trend in water purifiers is to make them smaller by effectively arranging various electrical components within a limited volume. However, when arranging the various components in such a limited volume and forming multiple wires to electrically connect each component, an electromagnetic interference (EMI) phenomenon may occur in which other components and wires are affected by noise generated from the electrical components and wires. That is, there is a problem in which the reception of a desired electronic signal is hindered by unnecessary electromagnetic signals or electromagnetic noise.

An induction heating type electronic device having enhanced EMI (Electro Magnetic Interference) reduction performance disclosed in LG Electronics Korean Patent Registration No. 2189491 discloses enhancing EMI reduction performance through a noisy printed circuit board, a live line and neutral line with some sections twisted, and first to fifth outer cores. However, in the case of the LG Electronics' induction heating type electronic device having enhanced EMI reduction performance, a separate noisy printed circuit board, etc. is required to remove noise of the AC power output from the input power unit and provide it to the induction heating printed circuit board, so there is a problem that the manufacturing cost increases and a separate space is required to install the noisy printed circuit board.

Apparatus and method for supplying hot water and water purifier having the same disclosed in Coway Co., Ltd.'s Korean Patent Registration No. 1897574 discloses suppressing EMI generation by organically controlling the operation of a first heater, a second heater, and a flow rate control valve depending on whether the target temperature is lower than or higher than or equal to a reference temperature. However, in this case as well, there is a problem that it requires separate members and algorithms to collect and process various information, including inlet and outlet temperatures, for organic control, and that it is limitedly applicable to hot water supply devices including multiple heaters.

(Patent Document 0001) Korean Patent Registration No. 2189491

(Patent Document 0002) Korean Patent Registration No. 1897574

### SUMMARY OF THE INVENTION

### Technical Problem

To solve the above problems, in the water purifier according to the present invention, the controller includes a power supply positioned on one side portion of the water treatment module and converting AC power into DC power; a first board arranged on the other side portion of the water treatment module and having a bridge circuit to branch out a portion of the external power and supply the AC power to the power supply; an external power line connected to the first board to supply the external power to the first board; and an AC power line extending from the first board and connected to the power supply to transmit the AC power to the power supply, wherein the external power line extends along a first side of the water treatment module, and the AC power line extends along a second side of the water treatment module, which is different from the first side, so as to be spaced apart from the external power line by a predetermined interval or more, so that the effect of noise of the AC power line on the external power line is minimized, and thus the electrical stability of the apparatus is improved.

The water purifier according to an exemplary embodiment of the present invention aims to increase space efficiency by effectively arranging the power supply in a limited space, by the external power line including an entry part, as a portion thereof which enters a rear part of the housing, that is fixed by a fixing bracket of the housing, and by the AC power line including a connection part, as a portion thereof adjacent to the rear part of the housing, that is connected to the power supply.

The water purifier according to an exemplary embodiment of the present invention aims to minimize electromagnetic interference (EMI) by arranging the entry part at least 30 mm apart from the connection part in the width direction of the housing.

The water purifier according to an exemplary embodiment of the present invention aims to minimize electromagnetic interference (EMI) by arranging the entry part at least 100 mm apart from the connection part in the height direction of the housing.

The water purifier according to an exemplary embodiment of the present invention aims to minimize electromagnetic interference (EMI) by arranging the entry part and the connection part parallel to each other.

The water purifier according to an exemplary embodiment of the present invention aims to stably distribute power to a plurality of electronic components by the water treatment module including a heater having a heating member to heat purified water and a cooler; by the controller including a second board having a control unit mounted thereon for controlling the overall operation of the water purifier; and by the power supply supplying the DC power to the thermoelectric element and the second board.

The water purifier according to an exemplary embodiment of the present invention aims to prevent generation of electromagnetic interference by separating the power supply and the first board from each other, and to improve the spatial efficiency inside the water purifier, by arranging the power supply at a rear part of the housing, by arranging the first board at a front part of the housing, and by arranging the water treatment module between the power supply and the first board.

The water purifier according to an exemplary embodiment of the present invention aims to minimize electromagnetic interference (EMI) by extending the external power line along the side region of the water treatment module and extending the AC power line along the bottom region of the water treatment module, thereby effectively separating the AC power line and the external power line.

The water purifier according to an exemplary embodiment of the present invention aims to improve the reliability of a separation between the AC power line and the external power line, by fixing and arranging the AC power line by a separate fixing member on a side surface of the cooler of the water treatment module or on an inner surface of the housing.

The water purifier according to an exemplary embodiment of the present invention aims to minimize the effect of noise from AC power lines on DC power lines, by arranging a DC power line extending from the power supply on the other side surface opposite to the AC power line based on the water treatment module.

### Technical Solution

To achieve the above objects, the water purifier according to the present invention may include a housing; a water treatment module arranged within the housing and processing raw water to produce purified water; a controller arranged within the housing and supplied with external power to control the operation of the water treatment module, wherein the controller includes a power supply positioned on one side portion of the water treatment module and converting AC power into DC power; a first board arranged on the other side portion of the water treatment module and having a bridge circuit to branch out a portion of the external power and supply the AC power to the power supply; an external power line entering from the outside of the housing to one side of the housing adjacent to the power supply and connected to the first board to supply the external power to the first board; and an AC power line extending from the first board and connected to the power supply to transmit the AC power to the power supply, wherein the external power line extends along a first side of the water treatment module, and the AC power line extends along a second side of the water treatment module, which is different from the first side, so as to be spaced apart from the external power line by a predetermined interval or more.

In the water purifier according to an exemplary embodiment of the present invention, the external power line includes an entry part, as a portion thereof which enters a rear part of the housing, that is fixed by a fixing bracket of the housing, and the AC power line includes a connection part, as a portion thereof adjacent to the rear part of the housing, that is connected to the power supply.

In the water purifier according to an exemplary embodiment of the present invention, the entry part may be arranged at a distance of 30 mm or more in the width direction of the housing from the connection part.

In the water purifier according to an exemplary embodiment of the present invention, the entry part may be arranged at a distance of 100 mm or more in the height direction of the housing from the connection part.

In the water purifier according to an exemplary embodiment of the present invention, the entry part may be arranged at a distance of 30 mm or more in the width direction of the housing and 100 mm or more in the height direction of the housing from the connection part.

In the water purifier according to an exemplary embodiment of the present invention, the entry part and the connection part may be arranged parallel to each other.

In the water purifier according to an exemplary embodiment of the present invention, the water treatment module may include a heater having a heating member to heat purified water; and a cooler arranged between the power supply and the first board and having a thermoelectric element to cool the purified water, and the controller may include a second board having a control unit mounted thereon for controlling the overall operation of the water purifier, and the power supply may supply the DC power to the thermoelectric element and the second board.

In the water purifier according to an exemplary embodiment of the present invention, the power supply may be arranged at a rear part of the housing, the first board may be arranged at a front part of the housing, and the water treatment module may be arranged between the power supply and the first board.

In the water purifier according to an exemplary embodiment of the present invention, the first side may refer to the side region of the water treatment module, and the second side may refer to the bottom region of the water treatment module.

In the water purifier according to an exemplary embodiment of the present invention, the AC power line may be fixed and arranged by a separate fixing member on a side surface of the cooler of the water treatment module or on an inner surface of the housing.

In the water purifier according to an exemplary embodiment of the present invention, the DC power line may be arranged on the other side surface of the water treatment module opposite to the first side based on the water treatment module.

### Advantageous Effects

According to the above configuration, in the water purifier according to the present invention, the controller includes a power supply positioned on one side portion of the water treatment module and converting AC power into DC power; a first board arranged on the other side portion of the water treatment module and having a bridge circuit to branch out a portion of the external power and supply the AC power to the power supply; an external power line connected to the first board to supply the external power to the first board; and an AC power line extending from the first board and connected to the power supply to transmit the AC power to the power supply, wherein the external power line extends along a first side of the water treatment module, and the AC power line extends along a second side of the water treatment module, which is different from the first side, so as to be spaced apart from the external power line by a predetermined interval or more, so that the effect of noise of the AC power line on the external power line is minimized, and thus the electrical stability of the apparatus is improved.

The water purifier according to an exemplary embodiment of the present invention can increase space efficiency by effectively arranging the power supply in a limited space, by the external power line including an entry part, as a portion thereof which enters a rear part of the housing, that is fixed by a fixing bracket of the housing, and by the AC power line including a connection part, as a portion thereof adjacent to the rear part of the housing, that is connected to the power supply.

The water purifier according to an exemplary embodiment of the present invention can minimize electromagnetic interference (EMI) by arranging the entry part at least 30 mm apart from the connection part in the width direction of the housing.

The water purifier according to an exemplary embodiment of the present invention can minimize electromagnetic interference (EMI) by arranging the entry part at least 100 mm apart from the connection part in the height direction of the housing.

The water purifier according to an exemplary embodiment of the present invention can minimize electromagnetic interference (EMI) by arranging the entry part and the connection part parallel to each other.

The water purifier according to an exemplary embodiment of the present invention can stably distribute power to a plurality of electronic components by the water treatment module including a heater having a heating member to heat purified water and a cooler; by the controller including a second board having a control unit mounted thereon for controlling the overall operation of the water purifier; and by the power supply supplying the DC power to the thermoelectric element and the second board.

The water purifier according to an exemplary embodiment of the present invention can prevent generation of electromagnetic interference by separating the power supply and the first board from each other, and improve the spatial efficiency inside the water purifier, by arranging the power supply at a rear part of the housing, by arranging the first board at a front part of the housing, and by arranging the water treatment module between the power supply and the first board.

The water purifier according to an exemplary embodiment of the present invention can minimize electromagnetic interference (EMI) by extending the external power line along the side region of the water treatment module and extending the AC power line along the bottom region of the water treatment module, thereby effectively separating the AC power line and the external power line.

The water purifier according to an exemplary embodiment of the present invention can improve the reliability of a separation between the AC power line and the external power line, by fixing and arranging the AC power line by a separate fixing member on a side surface of the cooler of the water treatment module or on an inner surface of the housing.

The water purifier according to an exemplary embodiment of the present invention can minimize the effect of noise from AC power lines on DC power lines, by arranging a DC power line extending from the power supply on the other side surface opposite to the AC power line based on the water treatment module.

### BRIEF DESCRIPTION OF THE DRAWINGS

FIG. 1 is a perspective view showing a water purifier according to an exemplary embodiment of the present invention.

FIG. 2 is an exploded perspective view showing a water purifier according to an exemplary embodiment of the present invention.

FIGS. 3 and 4 are perspective views showing the internal structure of a water purifier according to an exemplary embodiment of the present invention.

FIG. 5 is a view for describing the separation arrangement of an external power line and an AC power line of a water purifier according to an exemplary embodiment of the present invention.

FIGS. 6 and 7 are diagrams showing conducted emission test (CE) data of a water purifier according to an exemplary embodiment of the present invention and a water purifier for a control test, respectively.

FIGS. 8 and 9 are diagrams showing disturbance power test (DP) data of a water purifier according to an exemplary embodiment of the present invention and a water purifier for a control test, respectively.

### DETAILED DESCRIPTION OF THE EMBODIMENTS

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

It is understood that the terms “comprise” or “have” when used in this specification, are intended to describe the presence of stated features, integers, steps, operations, members, components and/or a combination thereof but not preclude the possibility of the presence or addition of one or more other features, integers, steps, operations, members, components, or combinations thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

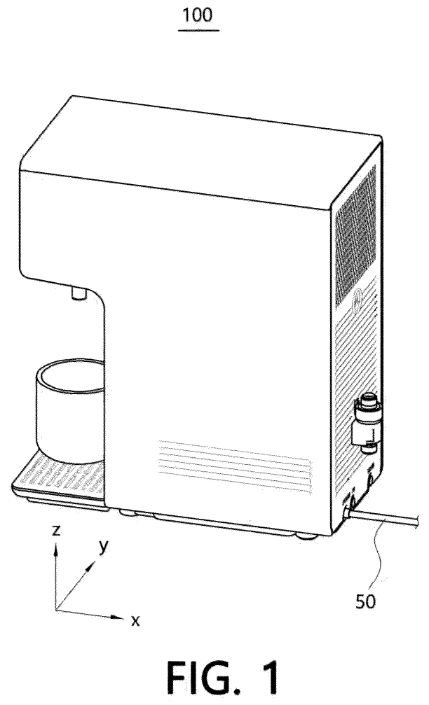

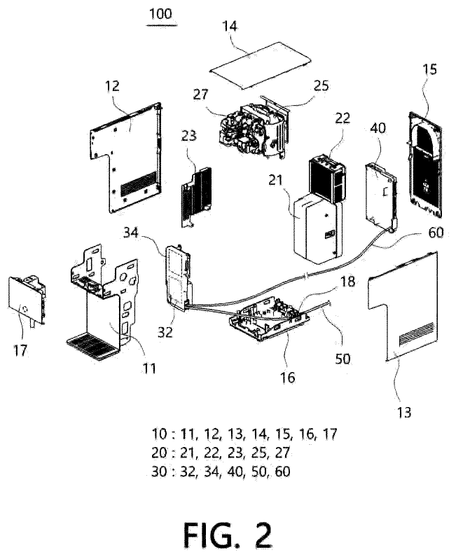

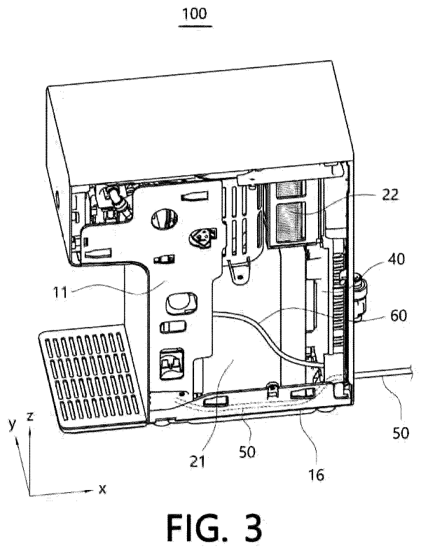

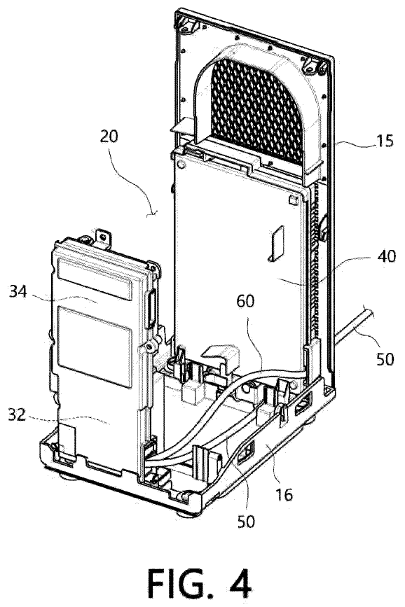

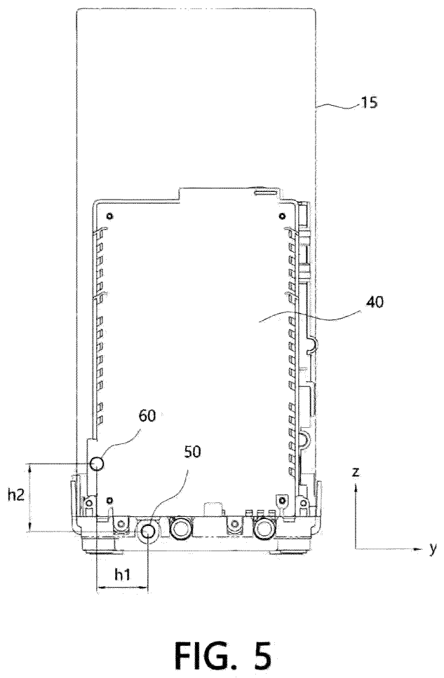

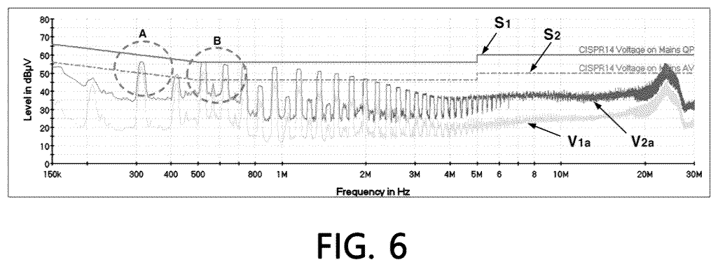

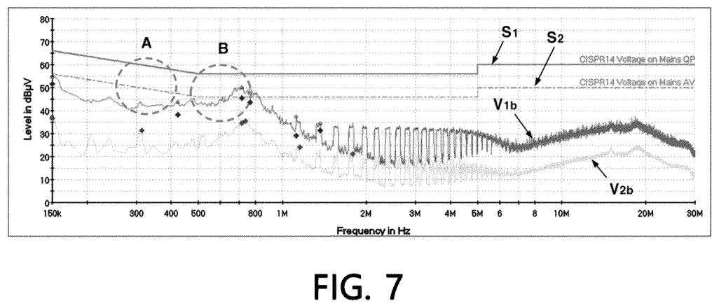

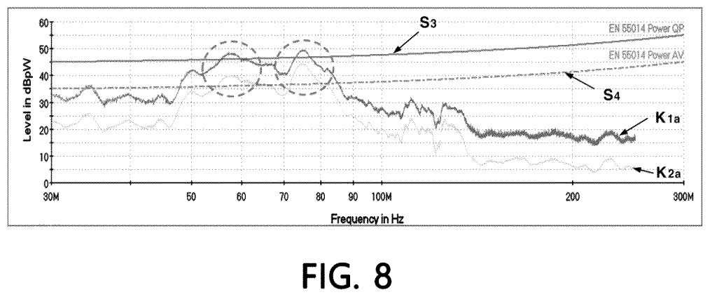

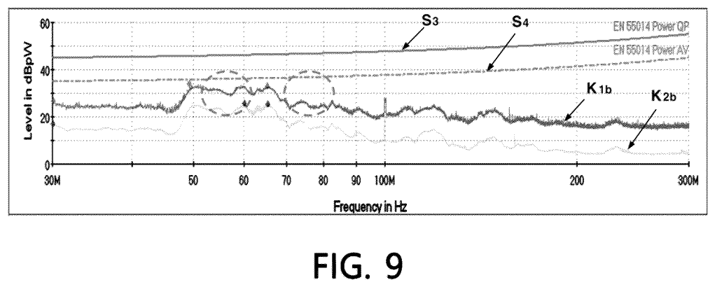

Hereinafter, a water purifier according to an exemplary embodiment of the present invention will be described with reference to the accompanying drawings. FIG. 1 is a perspective view showing a water purifier according to an exemplary embodiment of the present invention, and FIG. 2 is an exploded perspective view showing a water purifier according to an exemplary embodiment of the present invention. And FIGS. 3 and 4 are perspective views showing the internal structure of a water purifier according to an exemplary embodiment of the present invention, and FIG. 5 is a view for describing the separation arrangement of an external power line and an AC power line of a water purifier according to an exemplary embodiment of the present invention. In addition, FIGS. 6 and 7 are diagrams showing conducted emission test (CE) data of a water purifier according to an exemplary embodiment of the present invention and a water purifier for a control test, respectively, and FIGS. 8 and 9 are diagrams showing disturbance power test (DP) data of a water purifier according to an exemplary embodiment of the present invention and a water purifier for a control test, respectively.

Referring to FIG. 1, a water purifier 100 according to an exemplary embodiment of the present invention is an apparatus that operates by receiving external power from the outside, and includes a housing 10, a water treatment module (20) and a controller 30 arranged inside the housing 10.

First, the housing 10 is a member forming the outer surface of the water purifier 100 according to an exemplary embodiment of the present invention, and may have an internal space so that various members including the water treatment module 20 and the controller 30 can be arranged therein. As a specific example, referring to FIG. 2, a plurality of parts such as a front part 11, side parts 12 and 13, a top part 14, a rear part 15, a bottom part 16, and a display part 17 may be combined to form an internal space in the housing 10. However, the housing 10 illustrated in FIG. 2 is only an example, and the housing may be formed to have various shapes and structures other than the illustrated example. Therefore, the front part 11, side parts 12 and 13, top part 14, rear part 15, bottom part 16 and display part 17 described above should be interpreted as referring to a region ofthe combined housing, rather than referring to a separate part of the housing. In connection with this, in the following description, in referring to one region of the housing 10, a region adjacent to the outlet where purified water is discharged based on FIG. 1 is defined as the front part 11 of the housing, a region opposite to it is defined as the rear part 15, and a region covering the side of the water purifier between the front part 11 and the rear part 15 is defined as the side parts 12 and 13. In addition, one side adjacent to the ground is defined as the bottom part 16, and the other side facing it is defined as the top part 14.

Referring back to FIG. 2, the water purifier 100 according to an exemplary embodiment of the present invention includes a water treatment module 20 that processes raw water to generate purified water. In this case, the water treatment module 20 may not refer to a single member, but may refer to a set of a plurality of members used for generating purified water. In connection with this, the water treatment module 20 may largely include a cooler 21, a heat dissipation unit 22, a heater 23, a filter unit 25, and a valve unit 27.

In an embodiment of the present invention, the cooler 21 may include a cooler to cool and store purified water generated through the filter unit 25. In this case, the cooler may include a thermoelectric element to achieve thermoelectric cooling that cools the fluid using the Peltier effect. Accordingly, the cooler may perform the thermoelectric cooling by receiving DC power rectified from a power supply (switching mode power supply) 40, which will be described later, and may be disposed adjacent to the power supply 40, as shown in FIG. 3.

In addition, the heat dissipation unit 22 is a member for receiving heat generated by the cooler 21 and dissipating heat to the outside, and for this purpose, it may include a heat sink and a fan to induce efficient heat dissipation. In this case, the heat sink may be formed of a material with excellent thermal conductivity, such as an aluminum alloy, and may be formed in a structure in which a plurality of heat dissipation fins are arranged side by side to maximize heat transfer.

Next, the heater 23 may include a heating element that generates heat by receiving power to heat so that the purified water reaches a predetermined temperature. To this end, the heater 23 may place a planar heater in a tank in which purified water is stored, for example, and heat the purified water instantaneously.

In an embodiment of the present invention, the filter unit 25 is a member for generating purified water by filtering raw water supplied from the outside, and may include, for example, a reverse osmosis filter that generates purified water by filtering pressurized raw water. In this case, the reverse osmosis filter is equipped with a reverse osmosis membrane to divide the reverse osmosis filter member into a filtering side and a non-filtering side, and some of the raw water flowing into the non-filtering side is filtered while passing through the reverse osmosis membrane, and the remaining raw water may not pass through the reverse osmosis membrane. However, it is only an example that the filter unit 25 includes a reverse osmosis filter, and the filter unit 25 may employ any water purification filter as long as it is a water purification filter capable of filtering raw water.

Meanwhile, the valve unit 27 may collectively refer to a flow rate control member for controlling the inflow and outflow of fluid (raw water or purified water) toward the cooler 21, heater 23, and filter unit 25 described above. For example, the valve unit 27 may include a purified water valve for controlling the amount of water filtered through the filter unit 25 to be supplied to the cooler 21 or the heater 23, a cold water valve or a hot water valve or the like for controlling the discharge of cold water or hot water generated through the cooler 21 or the heater 23. In this case, a plurality of valves constituting the valve unit 27 may be integrally controlled by the controller 30 to be described later in consideration of the flow of the entire fluid inside the water purifier 100.

In addition, the water treatment module 20 may include, in addition to the above-described cooler 21, heater 23, filter unit 25, and valve unit 27 or the like, a pressing unit (not shown) to pressurize raw water, a preprocessing unit (not shown) to pretreat raw water before filtering into purified water, or a discharge unit (not shown) to discharge sewage generated during the water purification process, but detailed description thereof will be omitted because it is a configuration commonly provided in water purifiers.

In an embodiment of the present invention, as shown in FIG. 4, the above-described water treatment module 20 may be disposed between a first board 32 disposed adjacent to the front part 11 of the housing 10 and the power supply 40 disposed adjacent to the rear part 15 of the housing 10 in the internal space of the housing. That is, the water treatment module 20 may be disposed to spatially disconnect between the first board 32 and the power supply 40. Accordingly, the water treatment module 20 may spatially disconnect the first board 32 and the second board 34 including electric circuits, and the power supply 40 to which an excessive amount of power is supplied, thereby minimizing the electrical interaction that may occur between the two and arranging each member in a limited space efficiently.

Referring to FIGS. 2 and 4, the water purifier 100 according to an exemplary embodiment of the present invention includes, in addition to the water treatment module 20, a controller 30 that controls the operation of the water treatment module 20 by receiving external power. In this case, the controller 30 may not refer to a single member like the water treatment module 20, but may also refer to a set of a plurality of members for integrally performing the control function of the water treatment module 20. In this regard, the controller 30 may include a first board 32, a second board 34, a power supply 40, an external power line 50, and an AC power line 60.

First, the first board 32 is a member that constitutes an electrical circuit by mounting various electronic components such as semiconductors, resistors, and condensers on a printed circuit board (PCB), and may be disposed adjacent to the front part 11 of the housing, as shown in FIG. 4. In this case, as shown in the drawing, the external power line 50 is connected to the first board 32 so that external power (AC power) may be transmitted for the first time. In connection with this, the first board 32 may be provided with a bridge circuit (not shown) in part to branch out some of the external power source and then supply it to the power supply 40 through the AC power line 60 to be described later. In addition, as described above, the first board 32 may be arranged on one side of the water treatment module 20 in a form extending along the height direction (Z-axis direction) of the water purifier 100, and may be arranged to be spatially separated from the power supply 40 by the water treatment module 20. As a specific example, various electronic components for controlling the operation of the heater 23 including the heating element are mounted on the first board 32, so that the first board 32 may function as a heater PBA (printed board assembly). However, this is only an example, and it should be noted that the first board 32 refers to a member that is arranged on one side of the water treatment module 20 and receives external power, not to specifically refer to a member that functions as a heater PBA.

Next, the water purifier 100 according to an exemplary embodiment of the present invention may include a second board 34 disposed at a position adjacent to the first board 32. In this case, like the first board 32, the second board 34 is a printed circuit board on which a number of electronic components are mounted, and may be driven by receiving AC power or DC power supplied from the power supply 40. For example, the second board 34 may function as a main PBA including a control unit (not shown) for controlling the overall operation of the water purifier 100. However, it should be noted that the second board 34 does not refer to a member that functions as a main PBA like the first board 32, but rather refers to a PBA driven by receiving DC power from the power supply 40.

Meanwhile, in the above description, the first board 32 and the second board 34 are described as separate members, but the first board 32 and the second board 34 may exist integrally without being physically or spatially separated from each other. That is, members corresponding to the first board 32 and the second board 34 described above may be integrally disposed on a single PCB to form a single PBA. In this case, the first board 32 and the second board 34 described above should be interpreted as referring to some of the single type of PBA.

Next, the power supply 40 may be a power supply device for changing the characteristics of the AC power transmitted from the first board 32 and supplying it. For example, the power supply 40 may be a switching mode power supply (SMPS) that converts AC power into DC power using a switching operation, and may transmit the converted DC power to various members requiring power in the water purifier 100, such as the cooler 21, the first board 32, and the second board 34 of the water treatment module 20.

In an embodiment of the present invention, as shown in FIGS. 3 and 4, the power supply 40 may be disposed on one side of the water treatment module 20, and may be disposed in a form that stands upright in the height direction of the water purifier 100. In particular, the power supply 40 may be disposed adjacent to the rear part 15 of the housing so as to be spaced apart from the first board 32 disposed on the front part 11 of the housing. Accordingly, by arranging the power supply 40 on the rear part 15 of the housing, it is possible to minimize the heat generated from the power supply 40 from affecting other members. More specifically, in the case of conventional technology, there was a problem in that the temperature of cold water and purified water was increased due to heat from the power supply 40 as the power supply, which was highly heated, was arranged on the front part 11 side of the housing adjacent to the water outlet unit. In order to solve this problem, the water purifier 100 according to an exemplary embodiment of the present invention may solve the problem caused by heat generated from the power supply by arranging the power supply 40 on the rear part 15 of the housing far from the water outlet unit. However, when the power supply 40 is arranged on the rear part 15 of the housing like this, the AC power line 60 crosses the water treatment module 20 due to the spatial structure, resulting in EMI issues as it interacts with the external power line 50, and the water purifier 100 according to an exemplary embodiment of the present invention may effectively solve the EMI problem by separating the AC power line 60 and the external power line 50, as described later. This will be described in more detail through the following description.

In an embodiment of the present invention, the controller 30 may include an external power line 50 and an AC power line 60 to supply power to the first board 32, the second board 34, or the power supply 40 described above, or to electrically connect them.

First, the external power line 50 is a wiring member for supplying external power to the first board 32 and may enter the interior of the housing 10 through the rear part 15 of the housing as shown in the drawing. In this case, the external power line 50 entering the housing may extend along one side of the water treatment module 20 and then be connected to the first board 32 located adjacent to the front part 11 of the housing. As a specific example, referring to FIGS. 2 and 5, the external power line 50 may include an entry part 52 fixed by a fixing bracket 18 provided on the bottom part 16 of the housing as a part. In this case, the fixing bracket 18 may be fixed in the form of surrounding the external power line 50 by forming a space inside to allow the external power line 50 to pass, and through this, the external power line 50 may extend toward the first board 32 while maintaining one position without moving to either side.

In an embodiment of the present invention, the AC power line 60 is a wiring member connecting the first board 32 and the power supply 40 described above, and as described above, may transmit some of the AC power branched from the external power source to the power supply 40 through a bridge circuit provided in the first board 32. In this case, the AC power line 60 may be connected to the power supply 40 after extending along the other side of the water treatment module 20, for example, the side of the water treatment module 20, as shown in the drawing. In addition, as shown in FIG. 5, the AC power line 60 is a part adjacent to the entry part 52 of the external power line 50 and may include a connection part 62 connected to the power supply 40. In this case, like the entry part 52, the connection part 62 may be disposed at a position adjacent to the rear part 15 of the housing, and may be disposed parallel to the entry part 52 based on the X-axis direction of FIG. 3 (both the connection part 62 and the entry part 52 may be arranged to be perpendicular to the YZ plane of FIG. 3). In this way, when the entry part 52 and the connection part 62 are arranged in parallel, the external power line 50 and the AC power line 60 extending from the rear part 15 to the front part 11 of the housing may be arranged so as not to cross each other, thereby reducing the electromagnetic interference (EMI) phenomenon. (The separation distance between the external power line 50 and the AC power line 60 may be at least a first distance h1 and a second distance h2 (see FIGS. 3 and 5)).

In an embodiment of the present invention, the AC power line 60 may be disposed to be spaced apart from the external power line 50 by a predetermined interval or more. To this end, if the external power line 50 extends along the first side of the water treatment module 20, the AC power line 60 may extend along the second side of the water treatment module 20 distinguished from the first side. Here, it should be noted that the first side and the second side are terms referring to one region of the water treatment module 20, and they do not refer to absolute positions related to the water treatment module 20, but are relative positional concepts introduced to explain that the external power line 50 and the AC power line 60 extend apart so as not to overlap each other. Therefore, if the external power line 50 and the AC power line 60 are spaced apart from each other at a predetermined interval or more, for example, both the external power line 50 and the AC power line 60 may be arranged on the same side portion of the water treatment module 20, but may extend while maintaining a separate state. For example, the first side may be a lower surface of the water treatment module 20, and the second side may be a side surface of the water treatment module 20.

Meanwhile, it should be noted that the fact that the AC power line 60 and the external power line 50 are spaced apart by a predetermined interval or more does not mean that all of the total extension lengths of the AC power line 60 and the external power line 50 are spaced apart by the predetermined interval or more. That is, since both the AC power line 60 and the external power line 50 have one side connected to the first board 32, they may exceptionally be arranged very adjacent to each other in a position adjacent to the first board 32. For example, the separation of the AC power line 60 and the external power line 50 by a predetermined interval or more may mean that the cooler 21, which occupies the largest volume among the water treatment modules 20, and the AC power line 60 and the external power line 50 are spaced apart from each other by a predetermined interval or more in a region from a point where the AC power line 60 and the external power line 50 are in contact with each other to the rear part 15 of the housing.

In an embodiment of the present invention, the arrangement of the AC power line 60 and the external power line 50 spaced apart from each other is to minimize the occurrence of electromagnetic interference (EMI). Specifically, the inventors of the present invention were able to confirm that the occurrence of electromagnetic interference (EMI) was significantly reduced when the AC power line 60 and the external power line 50 were spaced apart while observing the degree of electromagnetic interference (EMI) by varying the arrangement of each part of the controller 30. Even in this case, as described above, the AC power line 60 and the external power line 50 may be exceptionally disposed adjacent to each other at positions adjacent to the first board 32. However, the inventors of the present invention were able to confirm that the occurrence of electromagnetic interference (EMI) was drastically reduced when the AC power line 60 and the external power line 50 were spaced apart by a predetermined interval or more in a region other than the position adjacent to the first board 32.

Referring to FIGS. 3 and 5 as specific examples related to the separation arrangement of the AC power line 60 and the external power line 50, the AC power line 60 may be disposed between the water treatment module 20 and the side part 13 of the housing, and the external power line 50 may be disposed between the water treatment module 20 and the bottom part 16 of the housing. (In this regard, the first side described above may be a lower surface of the water treatment module 20, and the second side may be a side surface of the water treatment module 20.) In this case, as shown in FIG. 5, the entry part 52 of the external power line and the connection part 62 of the AC power line may be disposed on the rear part 15 of the housing. According to this arrangement structure, the external power line 50 and the AC power line 60 are arranged closest to each other in a region adjacent to the rear part 15 of the housing (the part shown in FIG. 5) due to the spatial structure, and the gap may widen toward the front part 11 of the housing. Therefore, if the predetermined distance between the external power line 50 and the AC power line 60 is satisfied only on the rear part 15 of the housing, it can be naturally satisfied over the entire region except for the exception region adjacent to the first board 32.

In an embodiment of the present invention, the AC power line 60 may maintain one position while being fixed to the water treatment module 20 or the inner surface 13 of the housing in order to more stably secure a separation distance in relation to the external power line 50. As a specific example, the AC power line 60 may be attached and fixed to the side surface of the water treatment module 20 or the inner surface 13 of the housing through an adhesive tape, or may be maintained in a fixed position while inserted into a fixing member such as a ring or hook or the like formed on the side surface of the water treatment module 20 or the inner surface 13 of the housing.

In an embodiment of the present invention, the AC power line 60 may be disposed to be spaced apart from a DC power line extending from the power supply 40. In detail, the DC power rectified through the power supply 40 may be transmitted to the member side such as the first board 32 or the second board 34 through the DC power line. In this case, if the DC power line is arranged adjacent to the AC power line 60, noise generated from the AC power line 60 may also affect the DC power line, and to prevent this problem, the DC power line may be disposed to be spaced apart from the AC power line 60 by a predetermined distance or more. As an illustrative example, if the AC power line 60 is arranged on one side portion (between the cooler 21 and one side part 13 of the housing in FIG. 3) of the water treatment module 20 adjacent to one side part 13 of the housing, the DC power line may be disposed on the other side portion (between the cooler 21 and the other side part 12 of the housing in FIG. 3) of the water treatment module 20 adjacent to the other side part 12 of the housing. In this case, just like the AC power line 60, the DC power line may be fixed to the side surface of the water treatment module 20 or the inner surface 12 of the housing by tape, hook, or ring or the like to maintain a stable and constant position.

Regarding the predetermined interval between the external power line 50 and the AC power line 60, the inventors of the present invention performed a control test. In more detail, as shown in FIGS. 3 and 5, the inventors of the present invention performed a conducted emission test (CE) and a disturbance power test (DP), with the external power line 50 and the AC power line 60 arranged, by varying a first interval h1, which is the separation distance between the entry part 52 and the connection part 62 in the width direction of the housing 10 (Y-axis direction of FIG. 5) and a second interval h2, which is the separation distance in the height direction of the housing 10 (Z-axis direction of FIG. 5).

First, the results of the conducted emission test (CE) are as follows. When the first interval h1 is less than 30 mm or the second interval h2 is less than 100 mm as a control group, the results were derived that the quasi-peak value V1a satisfies a value equal to or less than the reference value S1 as shown in FIG. 6, but the average value V2a exceeds the reference value S2 for some bands A and B. In comparison, when the external power line 50 and the AC power line 60 are spaced apart so that the first interval h1 is 30 mm or more and the second interval h2 is 100 mm or more, as in the water purifier 100 according to an exemplary embodiment of the present invention, as shown in FIG. 7, both the quasi-peak value V1b and the average value V2b were reduced to form values equal to or less than the reference values S1 and S2.

Next, the results of the disturbance power test (DP) are as follows. Similarly, when the external power line 50 and the AC power line 60 are arranged so that the first interval h1 is less than 30 mm or the second interval h2 is less than 100 mm for the control group, as shown in FIG. 8, for some region (a part marked with a red circle), both the quasi-peak value K1a and the average value K2a were formed to be values equal to or greater than the reference values S3 and S4. In comparison, when the first interval h1 is secured by 30 mm or more and the second interval h2 is secured by 100 mm or more, the degree of electromagnetic interference was reduced so that both the quasi-peak value K1a and the average value K2a formed a value less than or equal to the reference values S3 and S4 over all regions as shown in FIG. 9.

As discussed, the water purifier 100 according to an exemplary embodiment of the present invention can spatially efficiently arrange a controller and a water treatment module within the limited internal space of the housing, while minimizing electromagnetic interference caused by interactions between external power lines and AC power lines without the introduction of separate shielding members or algorithms. As a result, the water purifier according to an exemplary embodiment of the present invention can improve electrical stability of an electronic apparatus and effectively satisfy an electromagnetic interference standard required for an electronic apparatus.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the scope of the same idea, but the embodiments will be also within the idea scope of the present invention.

1-11. (canceled)

12. A water purifier, comprising:
a housing;
a water treatment module arranged within the housing and configured to process raw water to produce purified water;
a controller arranged within the housing and supplied with external power to control operation of the water treatment module,
wherein the controller comprises:
a power supply positioned on a first side portion of the water treatment module and configured to convert AC power into DC power;
a first board arranged on a second side portion of the water treatment module and configured to have a bridge circuit to branch out a portion of the external power and supply the AC power to the power supply;
an external power line entering from outside of the housing to one side of the housing adjacent to the power supply and configured to be connected to the first board to supply the external power to the first board; and
an AC power line extending from the first board and configured to be connected to the power supply to transmit the AC power to the power supply,
wherein the external power line is configured to extend along a first side of the water treatment module,
wherein the AC power line is configured to extend along a second side of the water treatment module, which is different from the first side, and
wherein the AC power line is configured to be spaced apart from the external power line by a predetermined interval or more.

13. The water purifier of claim 12,
wherein the external power line comprises an entry part, as a portion thereof which enters a rear part of the housing, that is fixed by a fixing bracket of the housing, and
wherein the AC power line comprises a connection part, as a portion thereof adjacent to the rear part of the housing, that is connected to the power supply.

14. The water purifier of claim 13, wherein the entry part is configured to be arranged at a distance of 30 mm or more in a width direction of the housing from the connection part.

15. The water purifier of claim 13, wherein the entry part is configured to be arranged at a distance of 100 mm or more in a height direction of the housing from the connection part.

16. The water purifier of claim 13, wherein the entry part is configured to be arranged at a distance of 30 mm or more in the width direction of the housing and 100 mm or more in the height direction of the housing from the connection part.

17. The water purifier of claim 13, wherein the entry part and the connection part are configured to be arranged parallel to each other.

18. The water purifier of claim 12,
wherein the water treatment module comprises:
a heater having a heating member and configured to heat the purified water; and
a cooler arranged between the power supply and the first board and having a thermoelectric element to cool the purified water, and
wherein the controller comprises:
a second board having a control unit mounted thereon for controlling the overall operation of the water purifier, and
wherein the power supply is configured to supply the DC power to the thermoelectric element and the second board.

19. The water purifier of claim 12,
wherein the power supply is arranged at a rear part of the housing,
wherein the first board is arranged at a front part of the housing, and
wherein the water treatment module is arranged between the power supply and the first board.

20. The water purifier of claim 12, wherein the first side includes a side region of the water treatment module, and the second side includes a bottom region of the water treatment module.

21. The water purifier of claim 20, wherein the AC power line is fixed and arranged by a separate fixing member on a side surface of the cooler of the water treatment module or on an inner surface of the housing.

22. The water purifier of claim 20, further comprising:
a DC power line extending from the power supply to supply the DC power,
wherein the DC power line is arranged on an opposite side of the water treatment module to the first side based on the water treatment module.
